(19) United States
(12) Patent Application Publication
(10) Pub. No.: US 2026/0045150 A1
(43) Pub. Date: Feb. 12, 2026

(54) LOTTERY TICKET VENDING MACHINE WITH URGENT ACTION DATA TRANSMISSION

(71) Applicant: Brightstar Global Solutions Corporation, Providence, RI (US)

(72) Inventor: Medina Marie Topalian, East Greenwich, RI (US)

(21) Appl. No.: 18/796,905

(22) Filed: Aug. 7, 2024

(51) Int. Cl. G07F 17/32

(52) U.S. Cl. CPC G07F 17/329

(57) ABSTRACT

A system including a lottery ticket vending machine, wherein the system is configured responsive to an occurrence of a real-time reporting condition, determine urgent action data that is a subset of a vending machine operations data package, and cause an urgent action request notification, based on the urgent action data, to be displayed by the local user device, wherein causing the urgent action request notification to be displayed by the local user device.

### BACKGROUND

The present disclosure relates to lottery ticket vending machines.

Lottery tickets such as instant lottery tickets may be printed on a strip that may be rolled or fan-folded and provided as a pack of lottery tickets. Lottery tickets may be sold from such packs using lottery ticket vending machines. Data regarding the operation of the lottery ticket vending machines may be transmitted by the lottery ticket vending machines to a central system.

### BRIEF SUMMARY

In various embodiments, the present disclosure provides a lottery ticket vending machine positionable at a location, wherein the lottery ticket vending machine includes: a housing; a ticket drawer holder in the housing, the ticket drawer holder including a plurality of ticket drawers, each of the ticket drawers configured to hold a pack of instant lottery tickets; a ticket burster in the housing, the ticket burster configured to receive a lottery ticket and dispense the lottery ticket to a lottery ticket purchaser; and a network interface connector supported by the housing and communicatively connectable to a central lottery server and to a local server associated with a local user device positioned at the location. The lottery ticket vending machine further includes a controller including a processor and a memory device that stores a plurality of instructions, which when executed by the processor cause the processor to: generate a vending machine operations data package that includes operations data associated with operation of the lottery ticket vending machine, the operations data including a plurality of different data types; send the vending machine operations data package to the central lottery server via a lottery system communication interface; and responsive to an occurrence of a real-time reporting condition, determine urgent action data that is a subset of the vending machine operations data package, and cause an urgent action request notification, based on the urgent action data, to be displayed by the local user device. Causing the urgent action request notification to be displayed by the local user device includes generating an urgent action message based on the urgent action data and publishing the urgent action message to a data distribution interface in real-time.

In various other embodiments, the present disclosure provides a lottery ticket vending machine positionable at a location, wherein the lottery ticket vending machine includes: a housing; a ticket drawer holder in the housing, the ticket drawer holder including a plurality of ticket drawers, each of the ticket drawers configured to hold a pack of instant lottery tickets; a ticket burster in the housing, the ticket burster configured to receive a lottery ticket and dispense the lottery ticket to a lottery ticket purchaser; and a network interface connector supported by the housing and communicatively connectable to a central lottery server that shares a data distribution interface with a local server associated with a local user device at the location. The lottery ticket vending machine further includes a controller including a processor and a memory device that stores a plurality of instructions, which when executed by the processor cause the processor to: establish a lottery system communication interface between the central lottery server and the lottery ticket vending machine via the network interface connector; receive operations data associated with operation of the lottery ticket vending machine, the operations data including one of a plurality of different data types; generate cumulative vending machine operations data packages that each include operations data received during a respective operational time period of the lottery ticket vending machine; and responsive to a determination of a receipt of urgent operations data including an urgent action data type, cause an urgent action request notification, based on the urgent operations data, to be displayed by the local user device. Causing the urgent action request notification to be displayed by the local user device includes generating a first urgent action message based on the urgent operations data and transmitting the first urgent action message to the central lottery server to cause the central lottery server to publish a second urgent action message to the data distribution interface; and sending each of the cumulative vending machine operations data packages to the central lottery server via the lottery system communication interface after the operational time period associated with that cumulative vending machine operations data package.

In various other embodiments, the present disclosure provides a lottery ticket vending machine positionable at a location, wherein the lottery ticket vending machine includes: a housing; a ticket drawer holder in the housing, the ticket drawer holder including a plurality of ticket drawers, each of the ticket drawers configured to hold a pack of instant lottery tickets; a ticket burster in the housing, the ticket burster configured to receive a lottery ticket and dispense the lottery ticket to a lottery ticket purchaser; and a network interface connector supported by the housing and communicatively connectable to a local server associated with a local user device at the location. The lottery ticket vending machine includes a controller including a processor and a memory device that stores a plurality of instructions, which when executed by the processor cause the processor to: establish a data distribution interface between the local server and the lottery ticket vending machine via the network interface connector; receive operations data associated with operation of the lottery ticket vending machine, the operations data including one of a plurality of different data types; and responsive to a receipt of urgent operations data including an urgent action data type, cause an urgent action request notification, based on the urgent operations data, to be displayed by the local user device. Causing the urgent action request notification to be displayed by the local user device includes generating an urgent action message based on the urgent operations data and publishing the urgent action message to the data distribution interface.

Additional features are described in, and will be apparent from, the following Detailed Description and the figures.

### BRIEF DESCRIPTION OF THE SEVERAL VIEWS OF THE DRAWINGS

FIG. 1 is a front perspective view of a lottery ticket vending machine of one example embodiment of the present disclosure shown with a front door thereof in a closed position.

FIG. 2 is a front perspective view of the lottery ticket vending machine of FIG. 1 shown with the front door thereof in an open position, shown with a left side wall panel thereof removed, showing three ticket drawer holders and three movable ticket bursters respectively associated the three ticket drawer holders, and showing a ticket collection receptacle of the front door.

FIG. 3 is a front view of the lottery ticket vending machine of FIG. 1 shown with the front door thereof in the open position, shown with the left side wall panel thereof removed, showing the three ticket drawer holders and the three movable ticket bursters respectively associated the three ticket drawer holders, and showing the ticket collection receptacle of the front door.

FIG. 4 is a block diagram of a system for providing an urgent action request notification using a data distribution interface in accordance with one example embodiment of the present disclosure, and where the system includes the lottery ticket vending machine of FIG. 1, a central lottery server, and a local server.

FIG. 5 is a block diagram of the lottery ticket vending machine of FIG. 1, the central lottery server of FIG. 4, and the local server of FIG. 4, showing modules for establishing the data distribution interface.

FIG. 6 is a flow chart of an example process for providing the urgent action request notification via the system of FIG. 4.

FIG. 7 is a flow chart of another example process for providing the urgent action request notification via the system of FIG. 4 in accordance with an alternative embodiment of the present disclosure.

### DETAILED DESCRIPTION

In various embodiments, the present disclosure relates to a lottery ticket vending machine that includes a network interface connector communicatively connectable to a central lottery server and to a local server. In various embodiments, the lottery ticket vending machine also include a plurality of ticket drawers and one or more ticket bursters.

In various embodiments, the lottery ticket vending machine is configured to: (1) establish a data distribution interface between the local server and the lottery ticket vending machine via the network connector; and (2) cause an urgent action request notification to be displayed by a local user device that is associated with the local server, including generating and publishing an urgent action message to the data distribution interface in real-time.

In various embodiments, the lottery ticket vending machine is configured to: (1) establish a lottery interface between the central lottery server and the lottery ticket vending machine via the network interface connector; (2) generate a vending machine operations data package that includes operations data associated with operation of the lottery ticket vending; (3) send the vending machine operations data package to the central server via the lottery interface; (4) responsive to an occurrence of a real-time reporting condition, determine urgent action data that is a subset of the vending machine operations data package; (5) cause an urgent action request notification, based on the urgent action data, to be displayed by the local user device, including generating an urgent action message based on the urgent action data and publishing the urgent action message to the data distribution interface in real-time.

In various embodiments, the lottery ticket vending machine is configured to: (1) establish a lottery interface between the central lottery server and the lottery ticket vending machine via the network interface connector; (2) generate a vending machine operations data package that includes operations data associated with operation of the lottery ticket vending; (3) send the vending machine operations data package to the central server via the lottery interface; (4) responsive to an occurrence of a real-time reporting condition, determine urgent action data that is a subset of the vending machine operations data package; (5) cause an urgent action request notification, based on the urgent action data, to be displayed by the local user device, including causing the local server to publish in real-time an urgent action message to a data distribution interface associated with the local server.

In various embodiments, the urgent action request notification is associated with one or more user-serviceable actions on the lottery ticket vending machine that can be taken by a user of the local user device.

For a better understanding of the present disclosure, example instant lottery tickets are first generally described herein.

Various known instant lottery tickets are single game instant lottery tickets. An example single game instant lottery ticket can include: (1) a ticket substrate having a front surface and a back surface; (2) a predefined scratch-off area on the front surface; (3) variable lottery game indicia printed on the predefined scratch-off area; (4) a scratch-off coating (“SOC”) covering the variable lottery game indicia and the predefined scratch-off area; and (5) variable instant lottery ticket information indicia printed on the back surface. The instant lottery ticket information indicia can include text, one or more ticket numbers, one or more ticket barcodes, and other instant lottery ticket information that is in human readable and machine readable forms. Certain of this instant lottery ticket information: (a) identifies the instant lottery ticket; (b) the set, run, and/or pack of instant lottery tickets that the instant lottery ticket is part of; and (c) other inventory control information.

Various lottery tickets are often arranged after manufacture (which includes after complete printing) in lottery ticket packs for storage, organization, sorting, picking, shipping to lottery ticket distributors or ticket retailers, and validation. Instant lottery ticket packs can include a plurality of lottery tickets (that are all of the same type, same size, and for the same game(s), and can be protected for storage and shipping by a transparent pack wrapping, such as transparent plastic wrapping, securely wrapped around the plurality of lottery tickets. A pack of lottery tickets can include all of the lottery tickets attached to each other but joined by perforations. Such lottery tickets of a pack can be detached from each other along such perforations. While lottery tickets of each pack are often manufactured in a continuous strip that is fan-folded for convenient supply, the packs can be in other forms such as in a roll form. These packs in the fan-folded form or in the roll form are configured to dispensing via a lottery ticket vending machine.

Various lottery ticket vending machines can include various components such as but not limited to pinch rollers, stepper motors, and cutting blades to separate and dispense instant lottery tickets from a pack of lottery tickets, for example, within one or more ticket bursters. When a user purchases an instant lottery ticket, the ticket burster associated with a ticket drawer holding that purchased ticket moves into a ticket receipt position aligned with that ticket drawer to receive and dispense the purchased ticket.

Lottery ticket vending machines can also include various components such as but not limited to network interface connectors and printers to request and print draw lottery tickets. For various such lottery ticket vending machines, when a user purchases a draw lottery ticket, the lottery ticket vending machine creates and sends draw game wager request data to a central lottery server and causes the printer to print the draw lottery ticket.

Various components of a lottery ticket vending machine can experience one or more issue(s) that make one or more features of the lottery ticket vending machine unavailable to lottery ticket purchasers until such issue(s) are addressed. In some examples, a ticket drawer can become empty of instant lottery tickets such that those instant lottery tickets cannot be dispensed or sold. In other examples, a paper supply for a printer of draw lottery tickets can become empty such that draw lottery tickets cannot be printed and dispensed or sold. In other examples, an occurrence of a jam in a ticket drawer and/or a ticket burster, a network connectivity issue (e.g., to the central lottery server), and/or a power supply issue (e.g., to the ticket burster) can prevent lottery tickets from being dispensed or sold.

In some scenarios, issue(s) with the lottery ticket vending machine can be addressed by an action performed by an employee of a store (or other location) at which the lottery ticket vending machine is located. For example, once notified of the issue(s), the employee can refill an empty ticket drawer, refill a paper supply for a lottery draw lottery ticket printer, cause a jam to be cleared, etc.

Although it is known to provide certain notifications for such issues by a central lottery server associated with the lottery ticket vending machine, such known notifications can be based on periodic reports compiled from data received over a lengthy operational period (e.g., daily reports from a prior day of operation). Other notifications can be based on informal reports using data extracted in real time by a back office application, but such reports can require development and maintenance of additional applications that support distribution of the reports. Extensive delays associated with such periodic reports are carried through to any corrective action, which is frustrating to users trying to purchase tickets from the lottery ticket vending machine.

In various embodiments, the lottery ticket vending machine described herein is configured to provide an urgent notification to the employee via a local user device for that employee. In various such embodiments, the notification is provided to the local user device in real-time or near real-time. By providing an urgent notification, the lottery ticket vending machine enables a reduction and/or minimization of unavailability of the lottery ticket vending machine.

Additionally, in some scenarios, employees of a store at which the lottery ticket vending machine is located already use a suitable local user device, such as a tablet, smartphone, and/or point of sale user device. Such local user devices can be issued to the employee by an operator of the store to enable the employee to order and/or track inventory, respond to customer service requests, receive instructions from a manager, etc. Due to increased information technology security demands associated with lottery ticket vending machines, the lottery ticket vending machine can be communicatively isolated from such local user devices, which creates technical challenges for providing notifications related to the lottery ticket vending machine to the local user device.

In various embodiments, the lottery ticket vending machine described herein overcomes these challenges by publishing in real-time an urgent action message to a data distribution interface. In some embodiments, the local user device is a participant in the data distribution interface, directly receives the urgent action message, and displays an urgent action request notification to the employee. In some embodiments, a local server associated with the local user device is a participant in the data distribution interface, receives the urgent action message, and causes the urgent action request notification to be displayed by the local user device.

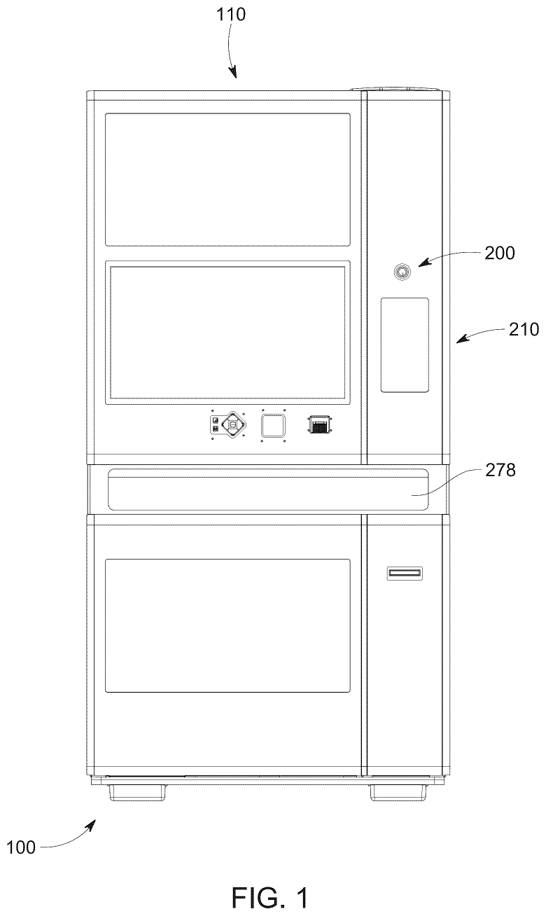

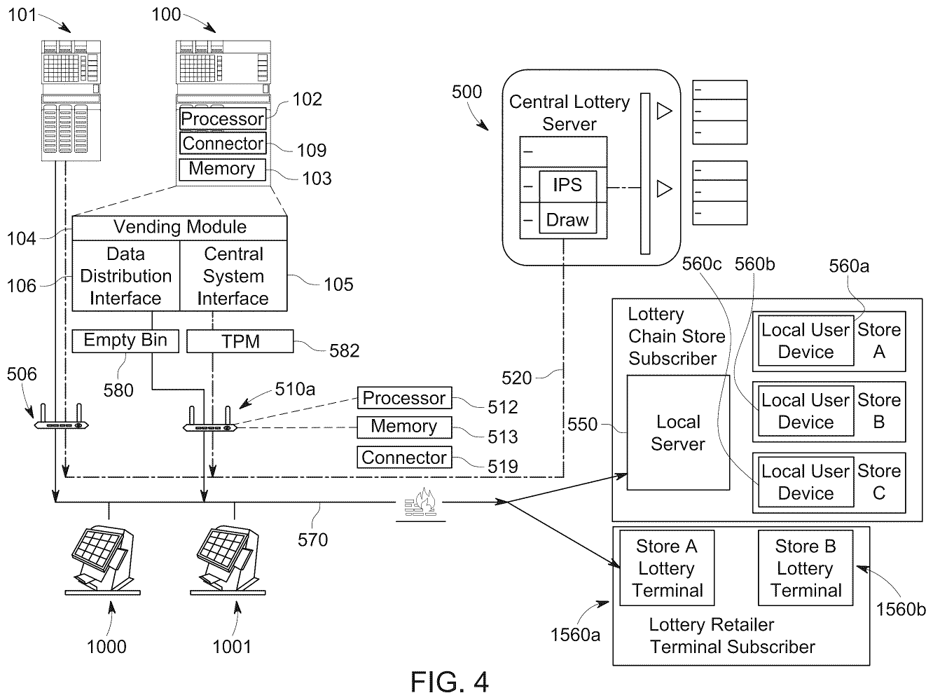

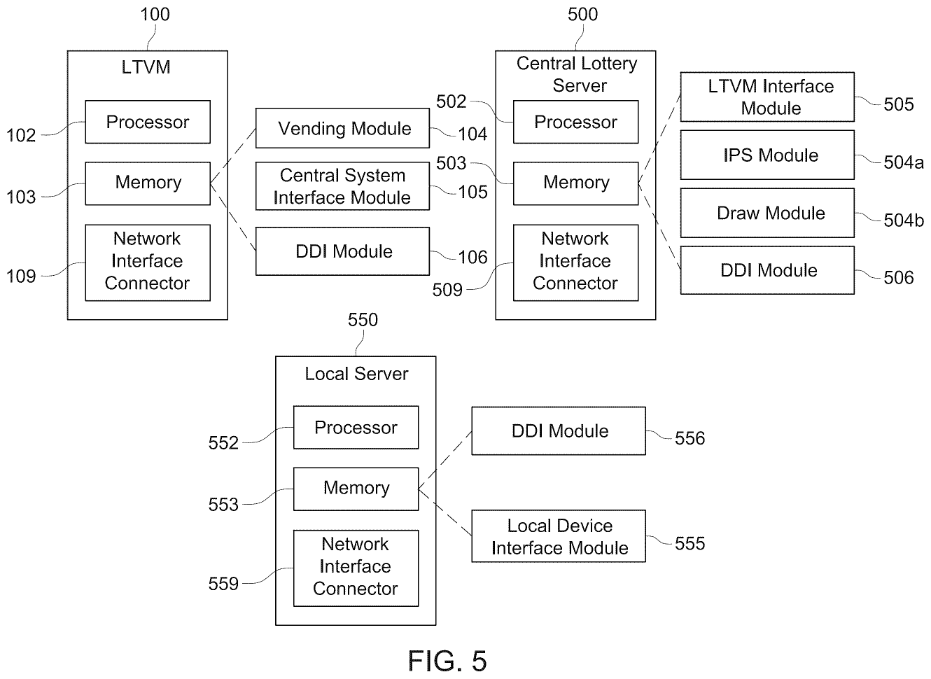

Turning now to FIGS. 1, 2, 3, 4, and 5, lottery ticket vending machine of one example embodiment of the present disclosure are generally illustrated and indicated by numerals 100 and 101. The lottery ticket vending machines 100 and 101 may be referred to herein as the “ticket vending machine” or the “vending machine” for brevity. Additionally, only the lottery ticket vending machine 100 is described in detail herein for brevity. As shown in FIG. 4, a system for providing an urgent action request notification using a data distribution interface includes the lottery ticket vending machine 100, a central lottery server 500, and a local server 550. In various embodiments, the system also includes one or more of a local user device and/or a secured router.

The illustrated example ticket vending machine 100 includes: (a) a machine housing 110 including a front door 200; (b) three ticket drawer holders 300a, 300b, and 300c positioned in and supported by the machine housing 110; (c) three separate and independently movable ticket bursters 400a, 400b, and 400c positioned in the machine housing 110 and supported by burster supporters (not labeled) positioned in and supported by the machine housing 110; (d) a processor 102; (e) a memory 103; and (f) a network interface connector 109. The front door 200 includes a ticket collection receptacle 250 configured to receive separated lottery tickets from each of the ticket bursters 400a, 400b, and 400c. The quantity, positions, sizes, and configurations of the ticket drawer holders and the ticket bursters can vary in accordance with the present disclosure.

It should be appreciated that the lottery ticket vending machine 100 includes various other components that are conventional in the industry and/or that would be readily apparent to those of ordinary skill in the art. For example, the lottery ticket vending machine 100 can include: (1) various electronic components (not shown) some of which can be contained in an electronic component holder (not labeled) positioned in and supported by the machine housing 110; and (2) various purchaser interface components (not labeled) that are part of the front door 200 of the machine housing 110. These components are only briefly described herein for brevity. Such electronic components can be arranged in any suitable manner. The electronic component holder can be in the form of a slide-out drawer to facilitate access to the various electronic components contained therein. The electronic components can form part of the control system for the ticket vending machine 100. Various electronic components can also be positioned in the machine housing 110 outside of the electrical component holder. The electronic components can include one or more controllers that control the operation of the ticket vending machine 100 including the movable ticket bursters 400a, 400b, and 400c as further discussed herein to facilitate the dispensing of each requested lottery ticket and the determination of any position issues of the lottery tickets (such as further described below). The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the ticket vending machine 100. In the embodiment shown in FIG. 4, the lottery ticket vending machine 100 includes the processor 102 as a controller and the memory 103 as the suitable memory. The purchaser interface components include one or more display devices, one or more input devices, and one or more payment acceptors. The purchaser interface components enable purchasers to use such components to determine the lottery tickets available from the ticket vending machine 100, and to select and pay for any of those lottery tickets held by the ticket vending machine 100 that the purchaser desires to obtain. The purchaser interface components can display images and information to inform purchasers of the different lottery tickets available from the ticket vending machine 100 and to assist in completing the selection and purchase of such lottery tickets. These electronic components and purchaser interface components can take many different forms as well known in the industry, and are thus not described in detail herein for brevity.

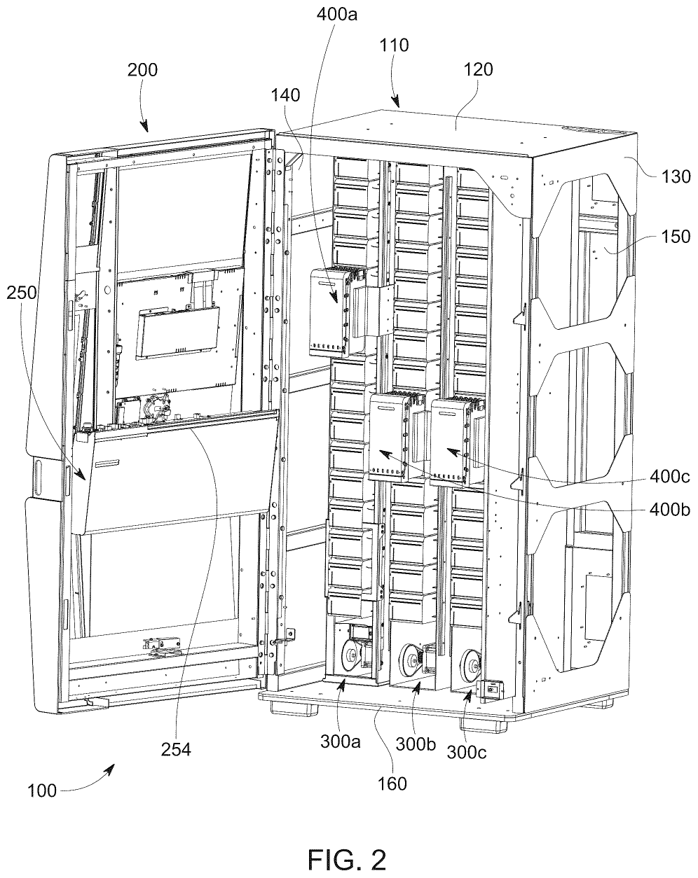

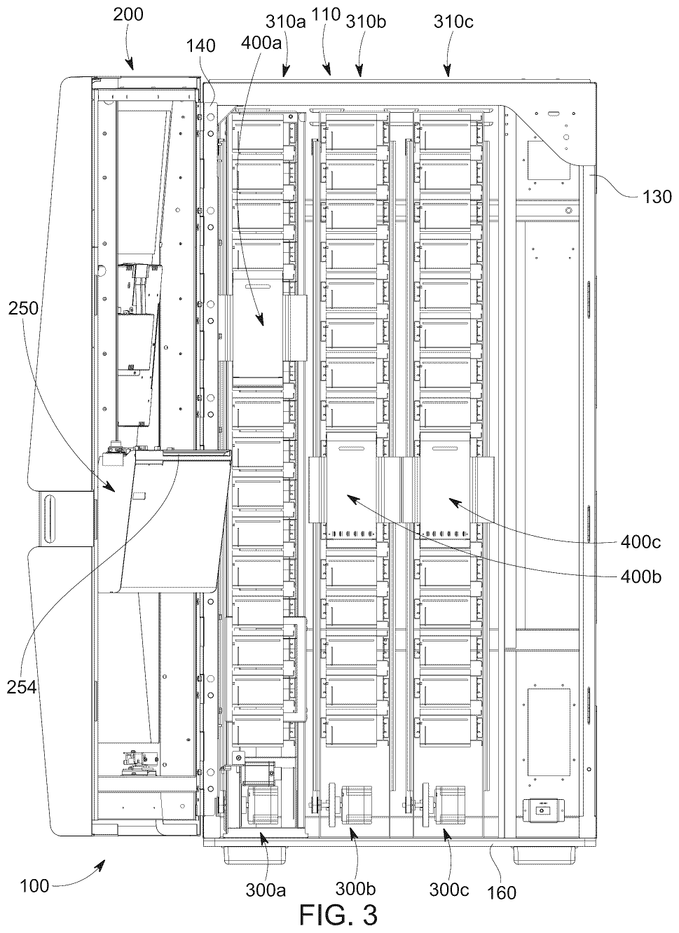

In this illustrated example embodiment, the machine housing 110 includes a top wall 120, spaced-apart side walls 130 and 140, a rear wall 150, a base 160, and the openable front door 200 pivotally connected to the side wall 140. The base 160 is configured to rest on a floor or other suitable support. The machine housing 110 includes suitable vertically extending supports (not labeled) configured to hold and support the respective ticket drawer holders 300a, 300b, and 300c. The front door 200 is moveable from a closed and locked position covering the open front face of the machine housing 110 as shown in FIG. 1 to an open position allowing access to the interior of the machine housing 110 as shown in FIGS. 2 and 3. The front door 200 is mounted by hinges (not labeled) to the side wall 140 of the machine housing 110. A suitable locking mechanism (not shown) is mounted on the front door 200 and the side wall 130 of the machine housing 110 to facilitate locking of the front door 200 in the closed position. When the front door 200 is closed and locked, the interior of the machine housing 110 is generally secured so as to be inaccessible except by an authorized person. The front door 200 can include one or more areas for any components supported by the front door and/or that are contained in and/or protected by the structure of the front door 200. The front door 200 can include one or more openings such as for a glass panel that enables people to see into the machine housing 110 and for one or more of the purchaser interface components (such as those described below). The size and configuration of the machine housing can vary in accordance with the present disclosure.

The ticket collection receptacle 250 of the front door 200 is configured to receive lottery tickets from each of the movable ticket bursters 400a, 400b, and 400c. The ticket collection receptacle 250 is configured to hold each lottery ticket received from the movable ticket bursters to enable the respective purchaser to retrieve the dispensed lottery ticket from the ticket collection receptacle 250. The ticket collection receptacle defines an elongated horizontally extending ticket receiving slot 254 (best seen in FIGS. 2 and 3). The ticket collection receptacle 250 and the front door define an elongated horizontally extending purchase ticket retrieval slot 278 (best seen in FIG. 1). The purchase ticket retrieval slot 278 is (and needs to be) large enough so that a purchaser can insert the purchaser's hand through the purchase ticket retrieval slot 278 to retrieve lottery tickets that are dispensed into the ticket collection receptacle 250. The ticket receiving slot 254 is (and needs to be) small enough so that a purchaser cannot insert the purchaser's hand through the ticket receiving slot 254 and thereby cannot access any of the ticket drawers of the ticket drawer holders 300a, 300b, or 300c. The position, size, and configuration of the ticket collection receptacle can vary in accordance with the present disclosure.

Each of the ticket drawer holders 300a, 300b, and 300c and their respective ticket drawers (e.g., ticket drawers 310a of the ticket drawer holder 300a, ticket drawers 310b of the ticket drawer holder 300b, and ticket drawers 310c of the ticket drawer holder 300c) are identical in this example embodiment. For brevity, only ticket drawer holder 300a is described in detail herein. Likewise, the three movable ticket bursters 400a, 400b, and 400c are identical in this example embodiment. For brevity, only ticket burster 400a associated with the ticket drawer holder 300a is described herein.

Ticket drawer holder 300a includes a series of aligned ticket drawers 310a that are vertically stacked in the holder. Each of the ticket drawers is configured to hold one or more packs of lottery tickets such as instant lottery tickets for subsequent dispensing by the ticket vending machine 100. The ticket drawers can vary in quantity, size, and configuration depending upon the particular size of the ticket vending machine 100 and the quantity, size, and shapes of the lottery tickets that the ticket vending machine 100 can or will dispense. Each ticket drawer is configured to hold lottery tickets such as instant lottery tickets for selection by the purchasers. In various embodiments, the different ticket drawers can hold different lottery ticket packs for different lottery games, but it should be appreciated, that two or more ticket drawers can hold the same type of lottery tickets. In various embodiments, each of the ticket drawers is configured to feed each instant lottery ticket held by that ticket drawer into the associated ticket burster 400a when the ticket burster 400a is moved into alignment with such ticket drawer for receipt, bursting, and dispensing of that lottery ticket. This ticket movement can be caused by an actuation lever of the burster engaging a ticket movement assembly of the ticket drawer, or in another suitable manner. Bursting of the lottery ticket is the industry term for separating a lottery ticket from a pack of lottery tickets held in a ticket drawer. In this example embodiment, the ticket drawers do not burst the lottery tickets and do not need any mechanisms for bursting the lottery tickets, but rather the moveable ticket burster 400a bursts the lottery tickets fed by the ticket drawers in the ticket drawer holder 300a into that ticket burster 400a.

As shown in FIGS. 2 and 3, the movable ticket burster 400a is supported by one or more burster supporters (such as burster supporter 480a). The burster supporters can be any suitable structure(s) that support(s) the ticket burster 400a in a manner that enables the ticket burster 400a to vertically move to any of the different ticket receipt positions that are associated with and in alignment with the respective ticket drawers of the ticket drawer holder 300a. Each of the burster supporters also support the ticket burster 400a in a manner that enables the ticket burster 400a to vertically move to into alignment with the ticket receptacle 250.

The ticket vending machine 100 includes one or more actuators (not shown) that control movement of the ticket burster 400a under control of the controller of the ticket vending machine 100 and/or the controller of the ticket burster 400a. In this example, an actuator (not labeled) is mounted at the bottom of the ticket drawer holder 300a and coupled to the ticket burster 400a by suitable linkages (such as but not limited to pulleys and a drive belt (not labeled)). The actuator is configured to move the ticket burster 400a under the control of the controller(s) in the vertical (e.g., up and down) directions. The movable ticket burster 400a is thus moveable, via this actuator and linkages on the ticket burster supporters to different vertical positions including a plurality of the ticket receipt positions respectively associated and aligned with each of the ticket drawers of the ticket drawer holder 300a such that the ticket burster 400a is positioned to receive one or more of the lottery tickets stored in each respective ticket drawer of the ticket drawer holder 300a for obtaining and dispensing that instant lottery ticket into the ticket receptacle 250 for the purchaser as requested by the purchaser. It should be appreciated that the present disclosure contemplates that other implementations of the ticket burster and/or actuators can be employed in accordance with the present disclosure.

In various embodiments, although not shown for clarity, the ticket burster 400a generally includes: (a) a burster housing; (b) one or more burster supporter connecters; (c) a barcode reader in and supported by the burster housing; (d) a ticket cutter in and supported by the burster housing; (e) a plurality of ticket engagers supported by the burster housing; and (f) a burster controller. The ticket burster 400a is thus configured to burst perforations between a lottery ticket being dispensed and a next lottery ticket of the pack so as to enable the dispensed lottery ticket to be dispensed into the ticket receptacle 250. This prevents a person from improperly tearing a lottery ticket or being able to pull an extended number of lottery tickets from one of the ticket packs in one of the ticket drawers. It should be appreciated that the ticket burster 400a can be moved to a dispensing location for each lottery ticket dispensed, or for only certain lottery tickets dispensed.

In the embodiment shown in FIG. 4, the lottery ticket vending machine 100 includes the processor 102, the memory 103, and the network interface connector 109 that enables wired and/or wireless communication with remote devices, computers, and/or processors. In various embodiments, the network interface connector 109 includes one or more of an Ethernet interface connector, a Wi-Fi interface connector, a cellular interface connector (e.g., 3G, 4G, and/or 5G cellular interface), a Bluetooth interface connector, or other suitable network interface connector. In various embodiments, the lottery ticket vending machine 100 includes one network interface connector 109 for a plurality of network interfaces, such as a lottery interface 520 to the central lottery server 500 and a data distribution interface 570 to the local server 550, described below. In various embodiments, the lottery ticket vending machine 100 includes one network interface connector 109 for each such network interface.

In various embodiments, the lottery ticket vending machine 100 includes one or more modules that enable functionality as described herein. In other words, the modules form part of the control system for the lottery ticket vending machine 100. In the embodiment shown in FIG. 4, the lottery ticket vending machine 100 includes a vending module 104, a central system interface module 105, and a data distribution interface module 106 that are implemented as software and/or firmware modules stored within the memory 103 and include instructions that when executed by the processor 102 cause and/or configure the processor 102 to enable the functionality. In other embodiments, one or more of the modules 104, 105, and 106, and/or portions thereof can be implemented using application-specific integrated circuits or other suitable hardware. The vending module 104 is configured to control the operation of the lottery ticket vending machine 100, for example, to facilitate dispensing of each requested lottery ticket. The central system interface module 105 is configured to enable and control communications between the lottery ticket vending machine 100 and the central lottery server 500, for example, to facilitate activation of instant lottery tickets, processing of draw game wager requests for draw lottery tickets, and/or processing of ticket redemption requests for lottery tickets. The data distribution interface module 106 is configured to enable the data distribution interface 570, for example, to facilitate real-time communication between the lottery ticket vending machine 100 and one or more of the central server 500, the local server 550, and/or the local user devices 560a, 560b, and 560c. In various embodiments, the data distribution interface module 106 can be added to the lottery ticket vending machine 100 without extensive re-development of existing modules on lottery ticket vending machine 100 (e.g., without changes to the central system interface module 105, with minor changes to the vending module 104, etc.).

The central lottery server 500 includes a processor 502, a memory 503, and a network interface connector 509. It should be appreciated that the central lottery server 500 includes various other electronic components that are conventional in the industry and/or that would be readily apparent to those of ordinary skill in the art. The electronic components can include one or more controllers that control the operation of the central lottery server 500 to facilitate operation of the lottery ticket vending machine 100. The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the central lottery server 500. In the embodiment shown in FIG. 4, the central lottery server 500 includes the processor 502 as a controller and the memory 503 as the suitable memory. The network interface connector 509 enables wired and/or wireless communication with remote devices, computers, and/or processors. In various embodiments, the network interface connector 509 includes one or more of an Ethernet interface connector, a Wi-Fi interface connector, a cellular interface connector (e.g., 3G, 4G, and/or 5G cellular interface), a Bluetooth interface connector, or other suitable network interface connector. In various embodiments, the central lottery server 500 is configured to support one, two, three, or more network interfaces, as described herein. In various embodiments, the central lottery server 500 includes one network interface connector 509 for the lottery interface 520 to the lottery ticket vending machine 100. In various embodiments, the central lottery server 500 includes one network interface connector 509 for a plurality of network interfaces, such as the lottery interface 520 and the data distribution interface 570. It should be appreciated that the central lottery server 500 can be configured to support additional network interfaces using the same or additional network interface connectors.

In various embodiments, the central lottery server 500 includes one or more modules that enable functionality as described herein. In other words, the modules form part of the control system for the central lottery server 500. For example, the functionality can include activation of instant lottery tickets, processing of draw game wager requests for draw lottery tickets, processing of ticket redemption requests for lottery tickets, and other lottery ticket related functionality. In the embodiment shown in FIG. 4, the central lottery server 500 includes one or more lottery ticket modules 504a and 504b (e.g., instant processing system (IPS) module 504a and draw module 504b), a lottery ticket vending machine (LTVM) interface module 505, and a data distribution interface module 506 that are implemented as software and/or firmware modules stored within the memory 503 and include instructions that when executed by the processor 502 cause and/or configure the processor 502 to enable the functionality. In other embodiments, one or more of the modules 504a, 504b, 505, and 506 and/or portions thereof can be implemented using application-specific integrated circuits or other suitable hardware. The IPS module 504a is configured to control operations associated with instant lottery tickets, for example, to facilitate activation of instant lottery tickets and/or processing of ticket redemption requests for instant lottery tickets. The draw module 504b is configured to control operations associated with draw lottery tickets, for example, to facilitate processing of draw game wager requests for draw lottery tickets and/or processing of ticket redemption requests for draw lottery tickets. The LTVM interface module 505 is configured to enable and control communications between the central lottery server 500 and the lottery ticket vending machine 100, for example, to facilitate activation of instant lottery tickets, processing of draw game wager requests for draw lottery tickets, and/or processing of ticket redemption requests for lottery tickets. The data distribution interface module 106 is configured to enable the data distribution interface 570, for example, to facilitate real-time communication between the lottery ticket vending machine 100 and one or more of the central server 500, the local server 550, and/or the local user devices 560a, 560b, and 560c.

As described above, in various embodiments, the lottery ticket vending machine 100 is associated with increased information technology security demands and is communicatively isolated, for example, to prevent unauthorized access to information associated with the lottery ticket vending machine 100 and to enable authorized access via the central lottery server 500. In the embodiment shown in FIG. 4, a secured router 510a enables communication between the lottery ticket vending machine 100 and one or more remote devices, such as the central lottery server 500, the local server 550, and/or the local user devices 560a, 560b, and 560c. A secured router 510b enables communication between the lottery ticket vending machine 101 and one or more remote devices. In other embodiments, the secured router 510a enables communication for both the lottery ticket vending machine 100 and the lottery ticket vending machine 101. For brevity, only the secured router 510a is described herein in detail.

The secured router 510a includes a processor 502, a memory 503, and a network interface connector 509. It should be appreciated that the secured router 510a includes various other electronic components that are conventional in the industry and/or that would be readily apparent to those of ordinary skill in the art. The electronic components can include one or more controllers that control the operation of the secured router 510a to facilitate operation of the secured router 510a. The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the secured router 510a. In the embodiment shown in FIG. 4, the secured router 510a includes the processor 512 as a controller and the memory 513 as the suitable memory. The network interface connector 519 enables wired and/or wireless communication with remote devices, computers, and/or processors. In various embodiments, the network interface connector 519 includes one or more of an Ethernet interface connector, a Wi-Fi interface connector, a cellular interface connector (e.g., 3G, 4G, and/or 5G cellular interface), a Bluetooth interface connector, or other suitable network interface connector. In various embodiments, the secured router 510a is configured to support one, two, three, or more network interfaces (e.g., interfaces 520 and 570) over one, two, three, or more network interface connectors.

In various embodiments, the secured router 510a includes one or more modules (not shown) that enable functionality as described herein, such as a routing module, a firewall module, an encryption module, etc. These modules can be implemented as software and/or firmware modules stored within the memory 513 and include instructions that when executed by the processor 512 cause and/or configure the processor 512 to enable the functionality. In other embodiments, one or more of the modules and/or portions thereof can be implemented using application-specific integrated circuits or other suitable hardware.

In various embodiments, the lottery interface 520 is a network interface that enables data communication between the central lottery server 500 and one or more lottery ticket vending machines, such as the lottery ticket vending machine 100. The data communication can include vending machine operations data packages and/or urgent action messages, as described below. In various embodiments, the lottery interface 520 is a private network that is secured from unauthorized access, for example, unauthorized access by the local user devices 560a, 560b, and 560c, remote users (not shown) over the Internet, customers and/or individuals (not shown) within a store in which the lottery ticket vending machine 100 is located, etc. In various embodiments, the lottery ticket vending machine 100 is directly connected to the secured router 510a by a wired connection to provide improved security to the lottery interface 520. In various embodiments, the secured router 510a is connected to the central lottery server 500 by a cellular interface connector to provide improved security to the lottery interface 520.

In various embodiments, the local server 550 is associated with an operator of a store in which the lottery ticket vending machine 100 is located. In the embodiment shown in FIG. 4, the local server 550 is associated with three different stores (Store A, Store B, and Store C) that are each operated by a lottery chain store subscriber, such as a regional or national chain of hypermarkets (superstores), grocery stores, department stores, convenience stores, or other suitable retail stores.

The local server 550 includes a processor 552, a memory 553, and a network interface connector 559. It should be appreciated that the local server 550 includes various other electronic components that are conventional in the industry and/or that would be readily apparent to those of ordinary skill in the art. The electronic components can include one or more controllers that control the operation of the local server 550 to facilitate operation of the store, for example, inventory management, point of sale (POS) system management, etc. The controller(s) can be any suitable type of controller (such as a programmable logic controller) that includes any suitable processing device(s) (such as a microprocessor, a microcontroller-based platform, an integrated circuit, or an application-specific integrated circuit) and any suitable memory device(s) (such as random access memory, read-only memory, or flash memory). The memory device(s) store(s) instructions executable by the processing device(s) to control operation of the local server 550. In the embodiment shown in FIG. 4, the local server 550 includes the processor 552 as a controller and the memory 553 as the suitable memory. The network interface connector 559 enables wired and/or wireless communication with remote devices, computers, and/or processors. In various embodiments, the network interface connector 559 includes one or more of an Ethernet interface connector, a Wi-Fi interface connector, a cellular interface connector (e.g., 3G, 4G, and/or 5G cellular interface), a Bluetooth interface connector, or other suitable network interface connector.

In various embodiments, the local server 550 includes one or more modules that enable functionality as described herein. In other words, the modules form part of the control system for the local server 550. In the embodiment shown in FIG. 4, the local server 550 includes a local device interface module 555 and a data distribution interface module 556 that are implemented as software and/or firmware modules stored within the memory 553 and include instructions that when executed by the processor 552 cause and/or configure the processor 552 to enable the functionality. In other embodiments, one or more of the modules 505 and 506 and/or portions thereof can be implemented using application-specific integrated circuits or other suitable hardware. The local device interface module 555 is configured to communicate with local user devices within the store (e.g., local user devices 560a, 560b, and 560c), for example, to provide notifications and/or information to employees of the store and/or enable a point of sale (POS) system. In various embodiments, the local device interface module 555 includes an application programming interface (API) for communication with an application and/or module executed by the local user devices. The data distribution interface module 556 is configured to enable the data distribution interface 570, for example, to facilitate real-time communication between the local server 550 and one or more of the lottery ticket vending machine 100 and the central server 500.

The local user devices 560a, 560b, and 560c are associated with the store in which the lottery ticket vending machine 100 is located. For brevity, only the local user device 560a is described herein in detail. In various embodiments, the local user device 560a is a tablet, smartphone, point of sale (POS) user device (e.g., register, tablet, or handheld device), display device, or other suitable device that can provide a notification to a user. In various embodiments, such local user devices can be provided to an employee or placed in the store (e.g., in a stock room or other room for employees) by an operator of the store, for example, to enable the employee to order and/or track inventory, respond to customer service requests, receive instructions from a manager, etc. In other embodiments, the local user device is a personal device of the employee (e.g., a personal smartphone) that is configured to communicate with the local server 550, for example, by installing an application or module associated with the local device interface module 555. The local user device 560a includes one or more user interface devices, such as displays, touch screens, input devices (e.g., buttons, bar code readers), speakers, or other suitable components.

In various embodiments, the data distribution interface 570 is a network interface that enables communication between the lottery ticket vending machine 100 and one or more of the central lottery server 500 and the local server 550. As described above, the lottery interface 520 is a private network and as such, the data distribution interface 570 is independent of the lottery interface 520. In other words, the data distribution interface 570 provides an alternative and/or additional data path for communication of operations data associated with the lottery ticket vending machine 100 to the operator of the store in which the lottery ticket vending machine 100 is located.

In various embodiments, the data distribution interface 570 is a publish/subscribe interface, such as an implementation of a data distribution service (DDS), that includes various participants (i.e., a DomainParticipant data object of DDS, having data structures storing data and associated methods for interacting with such data), as described below. Each participant can be a publisher of messages having a particular topic, a subscriber to messages having a particular topic, or both a publisher and a subscriber for those messages. In some examples, a participant can be a publisher and/or subscriber to messages having any of a plurality of different topics. In various embodiments, the messages are associated with one or more other parameters and/or meta-data, such as a data type.

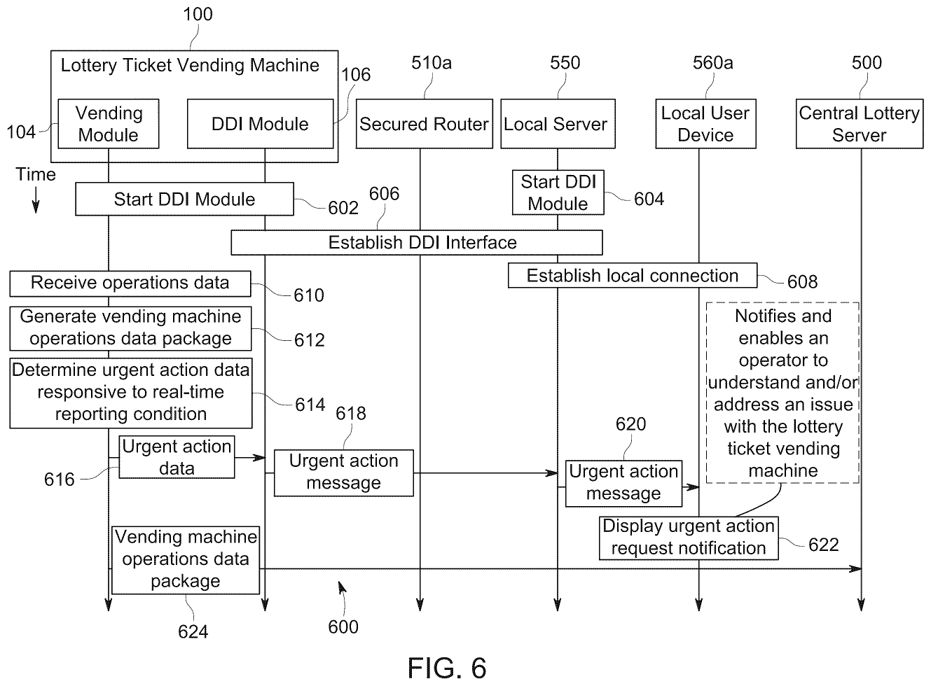

Turning now to FIG. 6, a flowchart of an example process 600 for providing an urgent action request notification via the system of FIG. 4 is shown. In various embodiments, the process 600 is represented by a set of instructions stored in one or more memories and executed by one or more processors (e.g., processors 102, 502, 512, and/or 552). In the process 600, devices having processors that perform an element of the process 600 are shown on top, with the elements generally occurring chronologically from top to bottom as shown. Although the process 600 is described with reference to the flowchart shown in FIG. 6, many other processes of performing the acts associated with this illustrated process may be employed. For example, the order of certain of the illustrated blocks may be changed, certain of the illustrated blocks may be optional, or certain of the illustrated blocks may not be employed.

The lottery ticket vending machine 100 enables the data distribution interface 570, as shown at block 602. In various embodiments, the vending module 104 causes the data distribution interface (DDI) module 106 to create a first participant data object associated with the lottery ticket vending machine 100 for the data distribution interface 570, for example, by requesting execution of the DDI module 106. The vending module 104 can request the execution of the DDI module 106 at any suitable time, such as: (1) at power-on of the lottery ticket vending machine 100; (2) during provisioning and/or initialization of the lottery ticket vending machine 100 by the lottery central server 500; (3) responsive to the occurrence of an event associated with the lottery ticket vending machine 100 (e.g., an occurrence of a real-time reporting condition); (4) responsive to a request received from the central lottery server 500; (5) responsive to a request received via a control and/or maintenance interface (not shown) of the lottery ticket vending machine 100; or (6) any other suitable time.

The local server 550 enables the data distribution interface 570, as shown at block 604. In various embodiments, the data distribution interface module 556 creates a second participant data object associated with the local server 550 for the data distribution interface 570, for example, responsive to a request for execution of the DDI module 556 by an application and/or operating system of the local server 550. The local server 550 can request the execution of the DDI module 556 at any suitable time, such as: (1) at power-on of the local server 550; (2) responsive to a request received from the central lottery server 500; (3) responsive to a request received via a control and/or maintenance interface (not shown) of the local server 550; or (4) any other suitable time.

In various embodiments, each of the first and second participant data objects are DomainParticipant data objects having a same domain identifier (e.g., “Lottery Ticket Notification for Store Operator A”). By using the same domain identifier, the DDI module 106 and the DDI module 556 are enabled to establish a communication connection over the data distribution interface 570. In some embodiments, the domain identifier is unique to the lottery ticket vending machine 100. In some embodiments, the domain identifier is unique to the operator of the store(s) in which one or more lottery ticket vending machines are located.

The DDI module 106 establishes the data distribution interface 570 with the local server 550, as shown at block 606. In various embodiments, the DDI module 106 creates a Publisher data object configured to publish messages to subscribers via the data distribution interface 570 and the DDI module 556 creates a Subscriber data object configured to subscribe to those messages. The DDI module 106 creates the Publisher data object (e.g., via its DomainParticipant data object) to include a suitable topic identifier (e.g., “Notifications for vending machine #45 at Store #17”) that identifies messages published by the lottery ticket vending machine 100. Similarly, the DDI module 556 creates the Subscriber data object (e.g., via its DomainParticipant data object) to include the same topic identifier (“Notifications for vending machine #45 at Store #17”) to establish the data distribution interface 570. In various embodiments, the first and second participant data objects share meta-data about each other to establish the data distribution interface 570. In certain other embodiments, the first participant data object of the lottery ticket vending machine 100 is configured to enable a static discovery process using preconfigured data, such as a unicast Internet Protocol address and port number associated with the local server 550, the domain identifier, the topic identifier, one or more data type(s), and/or other suitable data. In such embodiments, the lottery ticket vending machine 100 is enabled to establish the DDI interface 570 without exposing itself to discovery data traffic (e.g., by listening for other participants), which improves security of the data distribution interface 570.

The local server 550 establishes a local connection with the local user device 560a, as shown at block 608. For example, the local device interface module 555 establishes a communication connection with an application executed by the local user device 560a. In various embodiments, one or more of the applications executed by the local user device 560a and the local device interface module 555 are pre-existing modules associated with the operator of the store. In various embodiments, the local device interface module 555 includes an application programming interface configured to receive data and/or notifications to be provided to the local user device 560a and the data distribution interface module 556 is configured to provide data to the local device interface module 555 via that application programming interface. In such embodiments, the data distribution interface module 556 can be added to the local server 550, providing the notification functionality described herein, without extensive re-development of existing modules on the local server 550.

The vending module 104 receives operations data associated with operation of the lottery ticket vending machine 100, as shown at block 610. In various embodiments, the operations data can have any of a plurality of different data types, such as a sales transaction data type, ticket validation data type, a ticket redemption data type, a malfunction data type, a tamper incident data type, or other suitable data types. In various embodiments and/or scenarios, the vending module 104 receives operations data in real-time or near real-time. In certain other embodiments and/or scenarios, the vending module 104 receives operations data on a delayed basis (e.g., after an event associated with generation of the operations data).

The vending module 104 generates a vending machine operations data package based on the operations data, as shown at block 612. In various embodiments, the vending module 104 generates the vending machine operations data package in near real time. In various embodiments, the vending module 104 generates the vending machine operations data package to include operations data for a particular operational time period. For example, the vending module 104 can generate the vending machine operations data package to include operations data that was received during a previous hour, day, week, or other suitable operational time period. In some embodiments, the vending module 104 generates the vending machine operations data package on an ongoing basis during an operational time period, for example, by appending new operations data to the vending machine operations data package. In other embodiments, the vending module 104 generates the vending machine operations data package, based on stored operations data, responsive to an occurrence of an event, such as an end of the operational time period, a request for the vending machine operations data package from the central lottery server 500, etc.

In various embodiments, the vending machine operations data package includes the operations data and/or operations related metadata that represents the operations of the lottery ticket vending machine 100. In various embodiments, the operations data and/or metadata represents one or more of: (a) types of lottery tickets that have been purchased; (b) quantities of the different types of lottery tickets that have been purchased; (c) timestamps (e.g., time of day) associated with the purchase of the lottery tickets; (d) quantities of the different types of lottery tickets remaining within the lottery ticket vending machine 100; (e) amounts of cash, coins, and/or credits within the lottery ticket vending machine 100; (f) data associated with maintenance of the lottery ticket vending machine 100 (e.g., occurrence of a ticket jam, depletion of a ticket drawer, depletion of printer paper); (g) data associated with status and/or diagnostic tests of the lottery ticket vending machine 100 (e.g., status of a barcode reader, burster, printer, bill acceptor, cashless payment device); (h) data associated with network connectivity of the lottery ticket vending machine 100; and (i) data associated with errors, malfunctions, and/or operability of the lottery ticket vending machine 100 (such as main door open, tilt, or cash box open).

In various embodiments, the vending module 104 determines urgent action data responsive to a real-time reporting condition, as shown at block 614. In some examples, the urgent action data can include any of a ticket drawer empty notification, a ticket drawer jam notification, a vending machine malfunction notification, or other suitable urgent action message related data.

The vending module 104 provides the urgent action data to the DDI module 106 (block 616), which then generates and transmits an urgent action message to the local server 550 via the data distribution interface 570 at block 618. The DDI module 106 generates the urgent action message based on one or more of the urgent action data and the data distribution interface 570 (e.g., identifiers and/or parameters associated with the data distribution interface 570). In various embodiments, the DDI module 106 publishes the urgent action message to the data distribution interface 570 and the DDI module 556 of the local server 550, which is configured as a subscriber to such messages, receives the urgent action message. In the example shown in FIG. 4, the urgent action message includes a ticket drawer empty notification 580 (“Empty Bin”).

In various embodiments, the urgent action message includes data associated with a user-serviceable action on the lottery ticket vending machine 100 by a user of the local user device. In other words, the urgent action message indicates a current problem with the lottery ticket vending machine 100 that could, in some scenarios, be addressed by an employee of the store in which the lottery ticket vending machine 100 is located, such as by refilling an empty ticket drawer, refilling a paper supply for a lottery ticket printer, manually clearing a paper jam within the burster 400a and/or ticket drawer, causing a paper jam clearing routine to be performed by the burster 400a and/or ticket drawer, causing a diagnostic routine to be performed by the lottery ticket vending machine, verifying that electrical power is being provided to the lottery ticket vending machine 100, verifying that network connectivity is available to the lottery ticket vending machine 100, and/or placing the lottery ticket vending machine 100 in an out of order state (e.g., to enable customers to more efficiently utilize the lottery ticket vending machine 101 to purchase lottery tickets).

In various embodiments, the urgent action data is a subset of the vending machine operations data package, for example, operations data having a certain data type (e.g., a malfunction data type, a tamper incident data type, a network connection malfunction data type). In various embodiments, the vending module 104 is configured to include only urgent action data associated with a problem that can be addressed by the user of the local user device 560a. In such embodiments, the vending module 104 omits non-urgent data from the urgent action message, which reduces processing and communications overhead associated with operation of the lottery ticket vending machine 100.

In various embodiments, the real-time reporting condition includes one or more of: (1) a condition in which operations data received by the vending module 104 includes an urgent action data type, such as the malfunction data type and/or the tamper incident data type (such as Bin Burster Error, Printer Error, Coin Acceptor Error, or Coin Over Limit); (2) a condition in which the operations data is associated with a user-serviceable action on the lottery ticket vending machine (such as Paper Low, Bin Jammed, Bin Empty, Bin Low, or Bill Over Limit); (3) a condition in which a connection failure of the lottery interface 520 has occurred; (4) a condition in which a threshold quantity of operations data with non-urgent data types has been received; or (5) other suitable condition(s).

The local server 550 is configured to cause an urgent action request notification to be displayed by the local user device 560a responsive to the urgent action message. In various embodiments, the local device interface module 555 provides a suitable message to the local user device 560a via the API for communication with an application and/or module executed by the local user device 560a, as shown at block 620. In various embodiments, the suitable message is the same message as the urgent action message received from the DDI module 106. In other embodiments, the suitable message is a different message.

Responsive to the urgent action message from the local server 550, the local user device 560a displays an urgent action request notification, as shown at block 622. The urgent action request notification notifies and enables an operator (or the operator's employee) to understand and/or address an issue with the lottery ticket vending machine 100. In some examples, the notification includes, or is associated with, a description of a user-serviceable action on the lottery ticket vending machine 100 to be performed by a user of the local user device 560a. For example, the notification can display “Refill lottery ticket drawer #7 of vending machine #45” to request that the user add lottery tickets to a ticket drawer.

As described above, the vending module 104 generates the vending machine operations data package based on the operations data. The vending module 104 transmits the vending machine operations data package to the central lottery server 500 via the lottery interface 520, as shown at block 624. In the example shown in FIG. 4, the vending machine operations data package includes a touch point manager (TPM) report 582. In various embodiments, the vending module 104 transmits vending machine operations data packages according to a predetermined schedule, such as an hourly or daily schedule. In some such embodiments, the operator of the central lottery server 500 determines the schedule. In various embodiments, the vending module 104 transmits a vending machine operations data package at an end of a session, such as at an end of a ticket purchase transaction and includes transactional data. In various embodiments, the vending module 104 transmits the vending machine operations data package immediately, such as when the package includes data associated with a critical operational event.

It should be appreciated that although the vending machine operations data package is provided to the central lottery server 500 and an operator of the central lottery server 500 could then provide a notification to the operator of the store in which the lottery ticket vending machine 100 is located, any delays in communication and/or receipt of the vending machine operations data package increases a duration of unavailability of features of the lottery ticket vending machine 100. By providing a real-time notification via the data distribution interface 570, the lottery ticket vending machine enables a reduction and/or minimization of such duration.

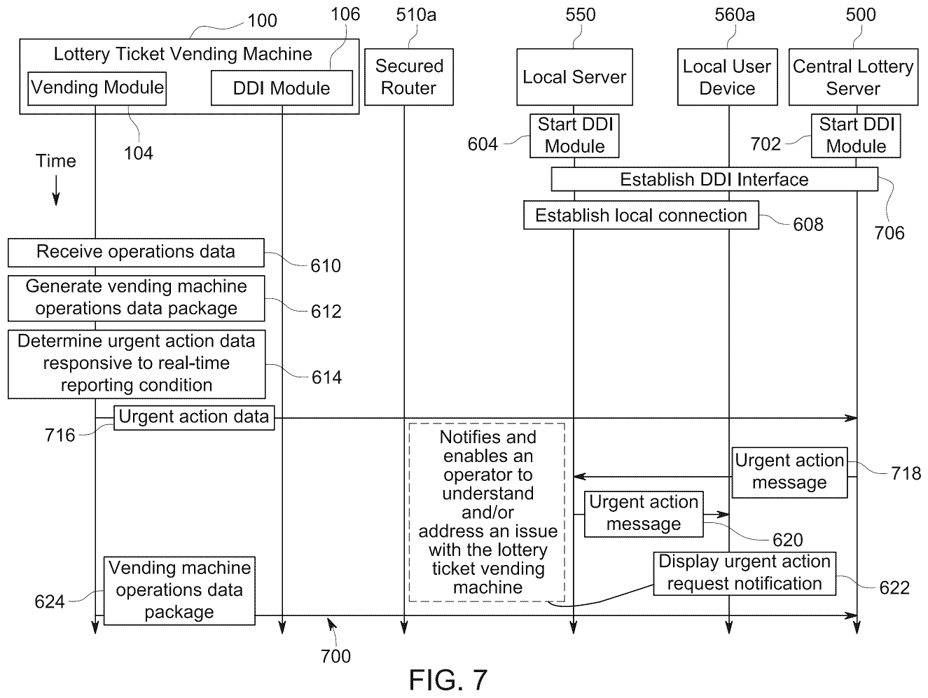

Turning now to FIG. 7, a flowchart of another example process 700 for providing an urgent action request notification via the system of FIG. 4 according to an alternative embodiment is shown. In various embodiments, the process 700 is represented by a set of instructions stored in one or more memories and executed by one or more processors (e.g., processors 102, 502, 512, and/or 552). In the process 700, devices having processors that perform an element of the process 700 are shown on top, with the elements generally occurring chronologically from top to bottom as shown. Although the process 700 is described with reference to the flowchart shown in FIG. 7, many other processes of performing the acts associated with this illustrated process may be employed. For example, the order of certain of the illustrated blocks may be changed, certain of the illustrated blocks may be optional, or certain of the illustrated blocks may not be employed.

The process 700 is similar to the process 600 and includes elements 604, 608, 610, 612, 614, 622, and 624 among different elements 702, 706, 716, 718, and 720, described below.

The central lottery server 500 enables the data distribution interface 570, as shown at block 702. In various embodiments, the central lottery server 500 causes the DDI module 506 to create a first participant data object associated with the central lottery server 500 for the data distribution interface 570, for example, by requesting execution of the DDI module 506. In various embodiments, the first participant data object associated with the central lottery server 500 corresponds to the first participant data object associated with the lottery ticket vending machine 100 described above with respect to FIG. 6. The central lottery server 500 can request the execution of the DDI module 506 at any suitable time, such as: (1) at power-on of the central lottery server 500; (2) during provisioning and/or initialization of the central lottery server 500; (3) responsive to the occurrence of an event associated with the central lottery server 500 (e.g., an occurrence of a real-time reporting condition); (4) responsive to a request received from the lottery ticket vending machine 100; or (5) responsive to a request received via a control and/or maintenance interface (not shown) of the central lottery server 500.

The local server 550 enables the data distribution interface 570, as shown at block 604, described above.

The DDI module 506 establishes the data distribution interface 570 with the local server 550, as shown at block 706. In various embodiments, the DDI module 506 creates a Publisher data object configured to publish messages to subscribers via the data distribution interface 570 and the DDI module 556 creates a Subscriber data object configured to subscribe to those messages, as described above.

The local server 550 establishes a local connection with the local user device 560a, as shown at block 608, described above.

The vending module 104 receives operations data associated with operation of the lottery ticket vending machine 100, as shown at block 610, described above.

The vending module 104 generates a vending machine operations data package based on the operations data, as shown at block 612, described above.

In various embodiments, the vending module 104 determines urgent action data responsive to a real-time reporting condition, as shown at block 614, described above.

The vending module 104 transmits the urgent action data to the central lottery server 500, as shown at block 716. In various embodiments, the vending module 104 transmits the urgent action data to the central lottery server 500 using the lottery interface 520.

Responsive to the urgent action data, the DDI module 506 of the central lottery server 500 generates and transmits an urgent action message to the local server 550 via the data distribution interface 570 at block 718. The DDI module 506 generates the urgent action message based on one or more of the urgent action data and the data distribution interface 570 (e.g., identifiers and/or parameters associated with the data distribution interface 570). In various embodiments, the DDI module 506 publishes the urgent action message to the data distribution interface 570 and the DDI module 556 of the local server 550, which is configured as a subscriber to such messages, receives the urgent action message.

The local device interface module 555 provides a suitable message to the local user device 560a, as shown at block 620, described above.

Responsive to the urgent action message from the local server 550, the local user device 560a displays an urgent action request notification, as shown at block 622, described above.

The vending module 104 transmits the vending machine operations data package to the central lottery server 500 via the lottery interface 520, as shown at block 624, described above.

It should be appreciated that the process 700 utilizes the central lottery server 500 as a participant of the data distribution interface 570, without the explicit use of the DDI module 106 of the lottery ticket vending machine 100. In various embodiments using the process 700, the data distribution interface module 106 is omitted from the lottery ticket vending machine 100 and as such, only minor modifications (or no modifications) of the lottery ticket vending machine 100 are needed to display the urgent action request notification by the local user device 560a.

In various embodiments, both the central lottery server 500 and the lottery ticket vending machine 100 are participants of the data distribution interface 570. In other words, elements of both the process 600 and the process 700 are performed. In some such embodiments, the DDI module 106 of the lottery ticket vending machine 100 is a publisher of the urgent action message at block 618, the DDI module 506 of the central lottery server 500 is a subscriber to and thus receives that urgent action message (e.g., via a Subscriber data object), and the DDI module 506 is also a publisher of the urgent action message at block 718. In such embodiments, the local server 550 receives two urgent action message via the data distribution interface 570. In other words, both the DDI module 506 and the DDI module 106 provide an urgent action message to the local server 550 via the data distribution interface 570, providing redundancy and improved reliability for causing the urgent action request notification. In some such embodiments, the central lottery server 500 receives both the urgent action data at block 716 via the lottery interface 520 and the urgent action message at block 618.

In some embodiments, the DDI module 106 of the lottery ticket vending machine 100 is a publisher of the urgent action message at block 618 and the vending module 104 also transmits the urgent action data to the central lottery server 500 at block 716. In such embodiments, the DDI module 106 is a publisher (e.g., at block 618), the DDI module 506 is a publisher (e.g., at block 718), and the DDI module 556 is a subscriber. In such embodiments, the local server 550 receives two urgent action message via the data distribution interface 570.

In various embodiments, the secured router 510a is configured to enable both the lottery interface 520 and the data distribution interface 570. For example, the routing module and/or firewall module can be configured to whitelist Internet Protocol addresses, port numbers, etc. associated with central lottery server 500 and/or the local server 550. In various embodiments, the firewall module of the secured router 510a is configured to allow data traffic received from the lottery ticket vending machine 100 (e.g., network interface connector 109) to be transmitted and/or forwarded to the local server 550 (e.g., the network interface connector 559). In various embodiments, the firewall module of the secured router 510a is configured to allow data traffic received from the lottery ticket vending machine 100 to be transmitted and/or forwarded to the central lottery server 500 (e.g., the network interface connector 509).

Although the secured router 510a is separate from the lottery ticket vending machine 100 as shown in FIG. 4, in other embodiments, the secured router 510a is integrated with the lottery ticket vending machine 100. In various embodiments, the secured router 510a is integrated into the processor 102. In various embodiments, the secured router 510a is provided as a dongle or adapter within the machine housing 110 and communicatively coupled with the processor 102.

Referring to FIG. 4, lottery ticket vending machines 1000 and 1001 are similar to the lottery ticket vending machine 100, but instead are directly connected to the Internet in an alternative embodiment. In such an embodiment, the secured router 510a is omitted and the network interface connector 109 is directly connected to the Internet, for example, by an unsecured router, modem, or other suitable communication device.

In various embodiments, local user devices 1560a and 1560b provide an additional and/or alternative user device with which to display the urgent action request notification. Only the local user device 1560a is described in detail herein for brevity. In various embodiments, the local user device 1560a is a retail lottery terminal (e.g., an “in-lane” terminal of a check-out lane) for use by an employee of a location at which the lottery ticket vending machine 100 is located. Such locations can include a gas station, grocery store, retail store, or other suitable location associated with a lottery retailer terminal subscriber. The local user device 1560a includes elements of both the local server 500 and the local user device 560a. In various embodiments, the local user device 1560a includes a processor (not shown), a memory (not shown), a network interface connector (not shown), and one or more user interface devices. The local user device 1560a includes the data distribution interface module 556 and as such, can enable and establish the data distribution interface 570 with the lottery ticket vending machine 100 and/or the central lottery server 500, receive the urgent action message, and display the urgent action request notification.

In the example embodiment described with respect to FIG. 4, the ticket drawers do not burst the lottery tickets and do not need any mechanisms for bursting and/or dispensing the lottery tickets, but rather the moveable ticket burster 400a bursts the lottery tickets fed by the ticket drawers in the ticket drawer holder 300a into that ticket burster 400a and dispenses the burst lottery ticket to the ticket receiving slot 254. In some alternative embodiments, the lottery ticket vending machine 100 includes one ticket burster for each ticket drawer within the ticket drawer holders 300a, 300b, and 300c. In such embodiments, another mechanism for dispensing the burst lottery tickets from the ticket bursters is provided, such as a quad burster mechanism having four independent ticket bursters.

It should be appreciated from the above that various embodiments of the present disclosure provide a lottery ticket vending machine comprising: (1) a housing; (2) a ticket drawer holder in the housing, the ticket drawer holder comprising a plurality of ticket drawers, each of the ticket drawers configured to hold a pack of instant lottery tickets; (3) a ticket burster in the housing, the ticket burster configured to receive a lottery ticket and dispense the lottery ticket to a lottery ticket purchaser; (4) a network interface connector supported by the housing and communicatively connectable to a central lottery server and to a local server associated with a local user device positioned at the location; (5) a controller including a processor and a memory device that stores a plurality of instructions, which when executed by the processor cause the processor to: (a) generate a vending machine operations data package that comprises operations data associated with operation of the lottery ticket vending machine, the operations data comprising a plurality of different data types; (b) send the vending machine operations data package to the central lottery server via a lottery system communication interface; and (c) responsive to an occurrence of a real-time reporting condition, (i) determine urgent action data that is a subset of the vending machine operations data package, and (ii) cause an urgent action request notification, based on the urgent action data, to be displayed by the local user device, wherein causing the urgent action request notification to be displayed by the local user device comprises generating an urgent action message based on the urgent action data and publishing the urgent action message to a data distribution interface in real-time. In various such embodiments, the plurality of instructions, when executed by the processor, cause the processor to: establish the lottery system communication interface between the central lottery server and the lottery ticket vending machine via the network interface connector; and establish the data distribution interface between the local server and the lottery ticket vending machine via the network interface connector. In various such embodiments, the plurality of instructions, when executed by the processor, cause the processor to establish the data distribution interface by creating a publisher data object configured to publish messages to a subscriber data object of the local server via the data distribution interface. In various such embodiments, the plurality of instructions, when executed by the processor, cause the processor to, responsive to the occurrence of the real-time reporting condition, transmit the urgent action data to the central lottery server via the lottery system communication interface. In various such embodiments, the plurality of instructions, when executed by the processor, cause the processor to: establish the data distribution interface between the central lottery server and the lottery ticket vending machine via the network interface connector; and responsive to the occurrence of the real-time reporting condition, transmit the urgent action data to the central lottery server via the data distribution interface. In various such embodiments, the plurality of instructions, when executed by the processor, cause the processor to establish the data distribution interface by creating a publisher data object configured to publish messages to a subscriber data object of the central lottery server. In various such embodiments, the urgent action data comprises one of a ticket drawer empty notification, a ticket drawer jam notification, and a vending machine malfunction notification. In various such embodiments, the real-time reporting condition comprises a receipt of operations data comprising an urgent action data type. In various such embodiments, the real-time reporting condition comprises a receipt of operations data that is associated with a user-serviceable action on the lottery ticket vending machine that is performable by a user of the local user device. In various such embodiments, the real-time reporting condition comprises a receipt of operations data that is associated with a connection failure of the lottery system communication interface.

It should further be appreciated from the above that various embodiments of the present disclosure provide a lottery ticket vending machine comprising: (1) a housing; (2) a ticket drawer holder in the housing, the ticket drawer holder comprising a plurality of ticket drawers, each of the ticket drawers configured to hold a pack of instant lottery tickets; (3) a ticket burster in the housing, the ticket burster configured to receive a lottery ticket and dispense the lottery ticket to a lottery ticket purchaser; (4) a network interface connector supported by the housing and communicatively connectable to a central lottery server that shares a data distribution interface with a local server associated with a local user device at the location; and (5) a controller including a processor and a memory device that stores a plurality of instructions, which when executed by the processor cause the processor to: (a) establish a lottery system communication interface between the central lottery server and the lottery ticket vending machine via the network interface connector; (b) receive operations data associated with operation of the lottery ticket vending machine, the operations data comprising one of a plurality of different data types; (c) generate cumulative vending machine operations data packages that each comprise operations data received during a respective operational time period of the lottery ticket vending machine; (d) responsive to a determination of a receipt of urgent operations data comprising an urgent action data type, cause an urgent action request notification, based on the urgent operations data, to be displayed by the local user device, wherein causing the urgent action request notification to be displayed by the local user device comprises generating a first urgent action message based on the urgent operations data and transmitting the first urgent action message to the central lottery server to cause the central lottery server to publish a second urgent action message to the data distribution interface; and (e) send each of the cumulative vending machine operations data packages to the central lottery server via the lottery system communication interface after the operational time period associated with that cumulative vending machine operations data package. In various such embodiments, the local server is a subscriber of the data distribution interface and to the second urgent action message. In various such embodiments, the plurality of instructions, when executed by the processor, cause the processor to transmit the first urgent action message to the central lottery server by publishing the first urgent action message to the data distribution interface. In various such embodiments, the plurality of instructions, when executed by the processor, cause the processor to establish the data distribution interface with the central lottery server as a subscriber. In various such embodiments, the plurality of instructions, when executed by the processor, cause the processor to transmit the first urgent action message to the central lottery server via the lottery system communication interface. In various such embodiments, the urgent operations data corresponds to one of a ticket drawer empty notification, a ticket drawer jam notification, and a vending machine malfunction notification. In various such embodiments, the urgent action data type comprises one of a malfunction data type, a tamper incident data type, and a network connection malfunction data type.

It should further be appreciated from the above that various embodiments of the present disclosure provide a lottery ticket vending machine comprising: (1) a housing; (2) a ticket drawer holder in the housing, the ticket drawer holder comprising a plurality of ticket drawers, each of the ticket drawers configured to hold a pack of instant lottery tickets; (3) a ticket burster in the housing, the ticket burster configured to receive a lottery ticket and dispense the lottery ticket to a lottery ticket purchaser; (4) a network interface connector supported by the housing and communicatively connectable to a local server associated with a local user device at the location; and (5) a controller including a processor and a memory device that stores a plurality of instructions, which when executed by the processor cause the processor to: (a) establish a data distribution interface between the local server and the lottery ticket vending machine via the network interface connector; (b) receive operations data associated with operation of the lottery ticket vending machine, the operations data comprising one of a plurality of different data types; and (c) responsive to a receipt of urgent operations data comprising an urgent action data type, cause an urgent action request notification, based on the urgent operations data, to be displayed by the local user device, wherein causing the urgent action request notification to be displayed by the local user device comprises generating an urgent action message based on the urgent operations data and publishing the urgent action message to the data distribution interface. In various such embodiments, the plurality of instructions, when executed by the processor, cause the processor to: establish a lottery system communication interface between a central lottery server and the lottery ticket vending machine via the network interface connector; generate a vending machine operations data package that comprises the urgent operations data and other operations data comprising a different data type; and send the vending machine operations data package to the central lottery server via the lottery system communication interface. In various such embodiments, the plurality of instructions, when executed by the processor, cause the processor to: generate a plurality of vending machine operations data packages that each comprise operations data received during a respective operational time period of the lottery ticket vending machine; and send each of the plurality of vending machine operations data packages to the central lottery server after the corresponding operational time period.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

1. A lottery ticket vending machine positionable at a location, the lottery ticket vending machine comprising:
a housing;
a ticket drawer holder in the housing, the ticket drawer holder comprising a plurality of ticket drawers, each of the ticket drawers configured to hold a pack of instant lottery tickets;
a ticket burster in the housing, the ticket burster configured to receive a lottery ticket and dispense the lottery ticket to a lottery ticket purchaser;
a network interface connector supported by the housing and communicatively connectable to a central lottery server and to a local server associated with a local user device positioned at the location;
a controller including a processor and a memory device that stores a plurality of instructions, which when executed by the processor cause the processor to:
generate a vending machine operations data package that comprises operations data associated with operation of the lottery ticket vending machine, the operations data comprising a plurality of different data types;
send the vending machine operations data package to the central lottery server via a lottery system communication interface; and
responsive to an occurrence of a real-time reporting condition,
determine urgent action data that is a subset of the vending machine operations data package, and
cause an urgent action request notification, based on the urgent action data, to be displayed by the local user device,
wherein causing the urgent action request notification to be displayed by the local user device comprises generating an urgent action message based on the urgent action data and publishing the urgent action message to a data distribution interface in real-time.

2. The lottery ticket vending machine of claim 1, wherein the plurality of instructions, when executed by the processor, cause the processor to:
establish the lottery system communication interface between the central lottery server and the lottery ticket vending machine via the network interface connector; and
establish the data distribution interface between the local server and the lottery ticket vending machine via the network interface connector.

3. The lottery ticket vending machine of claim 2, wherein the plurality of instructions, when executed by the processor, cause the processor to establish the data distribution interface by creating a publisher data object configured to publish messages to a subscriber data object of the local server via the data distribution interface.

4. The lottery ticket vending machine of claim 1, wherein the plurality of instructions, when executed by the processor, cause the processor to, responsive to the occurrence of the real-time reporting condition, transmit the urgent action data to the central lottery server via the lottery system communication interface.

5. The lottery ticket vending machine of claim 1, wherein the plurality of instructions, when executed by the processor, cause the processor to:
establish the data distribution interface between the central lottery server and the lottery ticket vending machine via the network interface connector; and
responsive to the occurrence of the real-time reporting condition, transmit the urgent action data to the central lottery server via the data distribution interface.

6. The lottery ticket vending machine of claim 5, wherein the plurality of instructions, when executed by the processor, cause the processor to establish the data distribution interface by creating a publisher data object configured to publish messages to a subscriber data object of the central lottery server.

7. The lottery ticket vending machine of claim 1, wherein the urgent action data comprises one of a ticket drawer empty notification, a ticket drawer jam notification, and a vending machine malfunction notification.

8. The lottery ticket vending machine of claim 1, wherein the real-time reporting condition comprises a receipt of operations data comprising an urgent action data type.

9. The lottery ticket vending machine of claim 1, wherein the real-time reporting condition comprises a receipt of operations data that is associated with a user-serviceable action on the lottery ticket vending machine that is performable by a user of the local user device.

10. The lottery ticket vending machine of claim 1, wherein the real-time reporting condition comprises a receipt of operations data that is associated with a connection failure of the lottery system communication interface.

11. A lottery ticket vending machine positionable at a location, the lottery ticket vending machine comprising:
a housing;
a ticket drawer holder in the housing, the ticket drawer holder comprising a plurality of ticket drawers, each of the ticket drawers configured to hold a pack of instant lottery tickets;
a ticket burster in the housing, the ticket burster configured to receive a lottery ticket and dispense the lottery ticket to a lottery ticket purchaser;
a network interface connector supported by the housing and communicatively connectable to a central lottery server that shares a data distribution interface with a local server associated with a local user device at the location;
a controller including a processor and a memory device that stores a plurality of instructions, which when executed by the processor cause the processor to:
establish a lottery system communication interface between the central lottery server and the lottery ticket vending machine via the network interface connector;
receive operations data associated with operation of the lottery ticket vending machine, the operations data comprising one of a plurality of different data types;
generate cumulative vending machine operations data packages that each comprise operations data received during a respective operational time period of the lottery ticket vending machine;
responsive to a determination of a receipt of urgent operations data comprising an urgent action data type, cause an urgent action request notification, based on the urgent operations data, to be displayed by the local user device,
wherein causing the urgent action request notification to be displayed by the local user device comprises generating a first urgent action message based on the urgent operations data and transmitting the first urgent action message to the central lottery server to cause the central lottery server to publish a second urgent action message to the data distribution interface; and
send each of the cumulative vending machine operations data packages to the central lottery server via the lottery system communication interface after the operational time period associated with that cumulative vending machine operations data package.

12. The lottery ticket vending machine of claim 11, wherein the local server is a subscriber of the data distribution interface and to the second urgent action message.

13. The lottery ticket vending machine of claim 12, wherein the plurality of instructions, when executed by the processor, cause the processor to transmit the first urgent action message to the central lottery server by publishing the first urgent action message to the data distribution interface.

14. The lottery ticket vending machine of claim 13, wherein the plurality of instructions, when executed by the processor, cause the processor to establish the data distribution interface with the central lottery server as a subscriber.

15. The lottery ticket vending machine of claim 12, wherein the plurality of instructions, when executed by the processor, cause the processor to transmit the first urgent action message to the central lottery server via the lottery system communication interface.

16. The lottery ticket vending machine of claim 11, wherein the urgent operations data corresponds to one of a ticket drawer empty notification, a ticket drawer jam notification, and a vending machine malfunction notification.

17. The lottery ticket vending machine of claim 11, wherein the urgent action data type comprises one of a malfunction data type, a tamper incident data type, and a network connection malfunction data type.

18. A lottery ticket vending machine positionable at a location, the lottery ticket vending machine comprising:
a housing;
a ticket drawer holder in the housing, the ticket drawer holder comprising a plurality of ticket drawers, each of the ticket drawers configured to hold a pack of instant lottery tickets;
a ticket burster in the housing, the ticket burster configured to receive a lottery ticket and dispense the lottery ticket to a lottery ticket purchaser;
a network interface connector supported by the housing and communicatively connectable to a local server associated with a local user device at the location;
a controller including a processor and a memory device that stores a plurality of instructions, which when executed by the processor cause the processor to:
establish a data distribution interface between the local server and the lottery ticket vending machine via the network interface connector;
receive operations data associated with operation of the lottery ticket vending machine, the operations data comprising one of a plurality of different data types; and
responsive to a receipt of urgent operations data comprising an urgent action data type, cause an urgent action request notification, based on the urgent operations data, to be displayed by the local user device,
wherein causing the urgent action request notification to be displayed by the local user device comprises generating an urgent action message based on the urgent operations data and publishing the urgent action message to the data distribution interface.

19. The lottery ticket vending machine of claim 18, wherein the plurality of instructions, when executed by the processor, cause the processor to:
establish a lottery system communication interface between a central lottery server and the lottery ticket vending machine via the network interface connector;
generate a vending machine operations data package that comprises the urgent operations data and other operations data comprising a different data type; and
send the vending machine operations data package to the central lottery server via the lottery system communication interface.

20. The lottery ticket vending machine of claim 19, wherein the plurality of instructions, when executed by the processor, cause the processor to:
generate a plurality of vending machine operations data packages that each comprise operations data received during a respective operational time period of the lottery ticket vending machine; and
send each of the plurality of vending machine operations data packages to the central lottery server after the corresponding operational time period.
